(19) United States
(12) Patent Application Publication
(10) Pub. No.: US 2005/0234870 A1
(43) Pub. Date: Oct. 20, 2005

(54) Automatic association of audio data file with document data file

(76) Inventors: Takafumi Onishi, Chofu-shi (JP); Yuichi Ito, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/100,227

(22) Filed: Apr. 6, 2005

(30) Foreign Application Priority Data
Apr. 14, 2004 (JP) 2004-119099

(51) Int. Cl. G06F 17/30

(52) U.S. Cl. 707/2

(57) ABSTRACT

A data processing apparatus comprises a storage medium configured to store a first data file, an ID generating part configured to generate an ID to identify the first data file, an ID information storage part configured to store the generated ID in association with the first data file, an ID giving part configured to give the generated ID to the stored first data file, and a transmission part configured to transmit, to an associated data generation apparatus, the first data file to which the ID has been given. The apparatus further comprises a receiving part configured to receive a second data file generated in the associated data generation apparatus, an ID detection part configured to detect the ID given to the received second data file, and an associating part configured to collate the detected ID with the stored ID, and associate the first data file with the second data file.

### CROSS-REFERENCE TO RELATED APPLICATIONS

This application is based upon and claims the benefit of priority from prior Japanese Patent Application No. 2004-119099, filed Apr. 14, 2004, the entire contents of which are incorporated herein by reference.

### BACKGROUND OF THE INVENTION

1. Field of the Invention

The present invention relates to automatic association of an audio data file with a document data file.

2. Description of the Related Art

Dictation, transcription and the like have heretofore been conducted wherein audio data, which has been recorded by, for example, an audio recording device such as a magnetic tape recorder or an IC recorder, is reproduced and, while listening to it, a typist or secretary types stated contents thereof.

Also, with the wide spread of personal computers (PCs), voice recognition software has recently undergone rapid progress. A data audio processing apparatus has therefore been proposed wherein voice is recorded by an audio recording device to create an audio data file which is converted into a document by means of the voice recognition software and saved as a document data file such as a text data file.

It is desirable to associate the audio data file created by a user with the document data file created from the audio data file. Such association avoids trouble when one wishes to collate the audio data file with the document data file corresponding to the audio data file and check them. That is, without the association, it is necessary for the user to go to the trouble of remembering the audio data file and the document data file in an associated manner or giving similar names to both files.

For example, Jpn. Pat. Appln. KOKAI Publication No. 2001-202372 has proposed a data processing apparatus to create matching data in which the audio data file is matched to the document data file such that the document data file corresponding to the audio data file can be opened with a simple operation. In this data processing apparatus, the document data file corresponding to the audio data file is manually selected and specified by the user to create the matching data for the audio data file and the document data file.

Furthermore, attention is directed to a transcription center as a new business model which offers a service wherein an audio data file transmitted from a user via e-mail or FTP is received and a document data file in which the contents of the audio data file have been converted into a document is returned to the user. When such a service is used, the matching data can be created in accordance with a technique such as the data processing apparatus disclosed in Jpn. Pat. Appln. KOKAI Publication No. 2001-202372 mentioned above unless the file name of the returned document data file has not been changed so that it differs from the file name of the audio data file.

### BRIEF SUMMARY OF THE INVENTION

According to a first aspect of the present invention, there is provided a data processing apparatus comprising:
a storage medium configured to store a first data file;
an ID generating part configured to generate an ID to identify the first data file stored in the storage medium;
an ID information storage part configured to store the ID generated by the ID generating part in association with the first data file;
an ID giving part configured to give the ID generated by the ID generating part to the first data file stored in the storage medium;
a transmission part configured to transmit, to an associated data generation apparatus, the first data file to which the ID has been given by the ID giving part;
a receiving part configured to receive a second data file generated in the associated data generation apparatus;
an ID detection part configured to detect the ID given to the second data file received at the receiving part; and
an associating part configured to collate the ID detected by the ID detection part with the ID stored in the ID information storage part, and associate the first data file with the second data file.

According to a second aspect of the present invention, there is provided an associated data generation apparatus comprising:
a receiving part configured to receive a first data file transmitted from a data processing apparatus;
an ID detection part configured to detect an ID given to the first data file received at the receiving part;
a data file generation part configured to generate a second data file associated with the first data file;
an ID giving part configured to give the ID detected by the ID detection part to the second data file generated by the data file generation part; and
a transmission part configured to transmit, to the data processing apparatus, the second data file to which the ID has been given by the ID giving part.

According to a third aspect of the present invention, there is provided a data processing system which transmits a first data file subjected to at least one of recording and processing in a data processing apparatus having first transmission and receiving parts, to an associated data generation apparatus having second transmission and receiving parts and which transmits a second data file generated by the associated data generation apparatus to the data processing apparatus, the data processing system comprising:
the data processing apparatus including:
   a storage medium configured to store the first data file;
   an ID generating part configured to generate an ID to identify the first data file stored in the storage medium;
   an ID association storage part configured to store the ID generated by the ID generating part in association with the first data file;
   a first ID giving part configured to give the ID generated by the ID generating part to the first data file stored in the storage medium; and
   the first transmission part configured to transmit, to the associated data generation apparatus, the first data file to which the ID has been given by the first ID giving part, and
the associated data generation apparatus including:
   the second receiving part configured to receive the first data file which has been transmitted from the first transmission part of the data processing apparatus and to which the ID has been given;
   a data file generation part configured to generate the second data file associated with the first data file received at the receiving part;
   a second ID giving part configured to give the ID which has been given to the first data file serving as an original of the second data file, to the second data file generated by the data file generation part; and
   the second transmission part configured to transmit, to the data processing apparatus, the second data file to which the ID has been given by the second ID giving part, wherein
the data processing apparatus further includes:
   the first receiving part configured to receive the second data file which has been transmitted from the second transmission part of the associated data generation apparatus and to which the ID has been given;
   an ID detection part configured to detect the ID given to the second data file received at the first receiving part; and
   an associating part configured to associate the first data file with the second data file in accordance with the ID detected by the ID detection part and information stored in the ID association storage part.

According to a fourth aspect of the present invention, there is provided a data processing software which causes a computer to perform data communication with an associated data generation apparatus, the data processing software causing the computer to perform:
a function to cause one of a user and the computer to select a first data file stored in a storage medium under the control of the computer;
a function to generate an ID to identify the selected first data file;
a function to store the generated ID in association with the first data file;
a function to give the ID to the first data file;
a function to transmit, to the associated data generation apparatus, the first data file to which the ID has been given;
a function to receive the second data file generated in the associated data generation apparatus;
a function to detect the ID given to the received second data file; and
a function to collate the detected ID with the stored ID, and associate the first data file with the second data file.

According to a fifth aspect of the present invention, there is provided an associated data generation software which causes a computer to perform data communication with a data processing apparatus, the associated data generation software causing the computer to perform:
a function to receive a first data file transmitted from the data processing apparatus;
a function to detect an ID given to the received first data file;
a function to generate a second data file associated with the received first data file;
a function to give the detected ID to the generated second data file; and
a function to transmit, to the data processing apparatus, the second data file to which the ID has been given.

According to a sixth aspect of the present invention, there is provided a data processing method of performing data communication with an associated data generation apparatus to process data, the method comprising:
selecting a first data file stored in a storage medium;
generating an ID to identify the selected first data file;
storing the generated ID in association with the first data file;
giving the ID to the first data file;
transmitting, to the associated data generation apparatus, the first data file to which the ID has been given;
receiving the second data file generated in the associated data generation apparatus;
detecting the ID given to the received second data file; and
collating the detected ID with the stored ID, and associating the first data file with the second data file.

According to a seventh aspect of the present invention, there is provided an associated data generating method of generating a second data file associated with a first data file transmitted from a data processing apparatus, the method comprising:
receiving the first data file transmitted from the data processing apparatus;
detecting an ID given to the received first data file;
generating a second data file associated with the first data file;
giving the detected ID to the generated second data file; and
transmitting, to the data processing apparatus, the second data file to which the ID has been given.

According to an eighth aspect of the present invention, there is provided a data processing method in which a first data file is transmitted from one side to another side, and a second data file associated with the first data file is generated at the another side and transmitted to the one side in order to process data, the method comprising:
at the one side
   generating an ID to identify the first data file stored in a storage medium;
   storing the generated ID in association with the first data file;
   giving the generated ID to the first data file; and
   transmitting, to the another side, the first data file to which the ID has been given, and
at the another side
   receiving the first data file to which the transmitted ID is given;
   generating the second data file associated with the received first data file;
   giving the ID which has been given to the first data file serving as an original of the second data file, to the generated second data file; and
   transmitting, to the one side, the second data file to which the ID has been given, wherein
further at the one side
   receiving the second data file to which the ID has been given;
   detecting the ID of the received second data file; and
   associating the first data file with the second data file in accordance with the detected ID and the ID stored in the one side.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of a data processing system according to one embodiment of the present invention;

FIG. 2 is a flowchart of “download processing of an audio data file to a PC” executed by a doctor-side PC in accordance with data processing software;

FIG. 3 is a diagram showing content of an XML file in a Dictation folder of the doctor-side PC at the time when the “download processing of the audio data file to the PC” has been finished;

FIG. 4 is a flowchart of “audio data file transmission processing” executed by the doctor-side PC in accordance with the data processing software;

FIG. 5 is a flowchart of “audio data file receiving processing” executed by a transcription-center-side PC in accordance with associated data generation software;

FIG. 6 is a diagram showing content of the XML file in a reception folder of the transcription-center-side PC at the time when the “audio data file receiving processing” has been finished;

FIG. 7 is a flowchart of “transcription processing” executed by the transcription-center-side PC in accordance with the associated data generation software;

FIG. 8 is a diagram showing content of the XML file in a Document folder of the transcription-center-side PC;

FIG. 9 is a flowchart of “document data file transmission processing” in FIG. 7;

FIG. 10 is a flowchart of “document data file receiving processing” executed by the doctor-side PC in accordance with the data processing software;

FIG. 11 is a flowchart of “audio data—document data link processing” in FIG. 10;

FIG. 12 is a diagram showing content of the XML file in the Dictation folder of the doctor-side PC where link information is described; and

FIG. 13 is a diagram showing content of the XML file in the Document folder of the doctor-side PC where the link information is described.

### DETAILED DESCRIPTION OF THE INVENTION

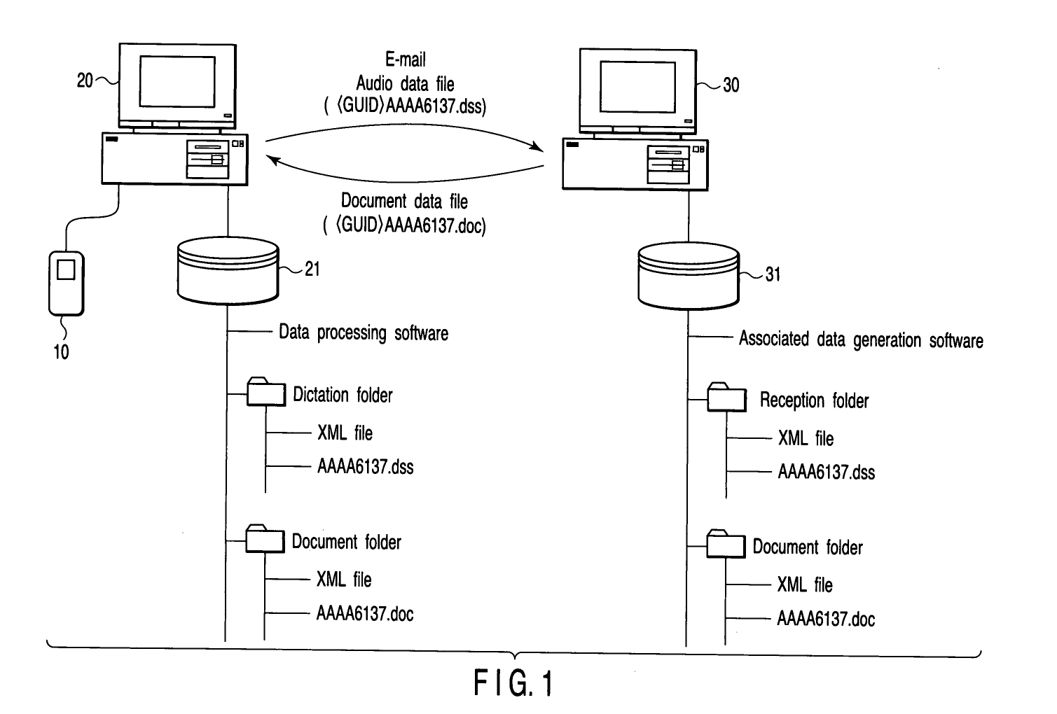

Hereinafter, one embodiment of the present invention will be described by way of example where a user is assumed to be a doctor and as shown in FIG. 1 processing is performed on an audio data file which has been recorded by the doctor on an audio recording and reproduction device (hereinafter referred to as an IC recorder 10) using an IC memory as a recording medium.

That is, a data processing system according to the one embodiment of the present invention comprises a user PC (a doctor-side PC 20 in this example) as a data processing apparatus to which the IC recorder 10 is connected, and a center PC (hereinafter noted as a transcription-center-side PC 30) as an associated data generation apparatus. The transcription-center-side PC 30 is located in a transcription center, and offers a service to create a second data file (in the present embodiment, a document data file in which contents of the audio data file have been converted into a document) associated with a first data file (in the present embodiment, the audio data file).

The doctor-side PC 20 comprises a CPU (not shown) to control each part, a storage medium (here a hard disk 21), RAM (not shown), a reproduction processing part (not shown) of the audio data file, and a user interface (not shown). Here, the hard disk 21 is used to store various program files such as data processing software of the present embodiment and various data files such as the audio data file recorded with the IC recorder 10. The RAM is a memory to temporarily store a program and data. The reproduction processing part includes a digital-to-analog (D/A) converter (not shown) to convert audio data into analog data, an amplifier (not shown) to amplify the converted analog data, a speaker (not shown) to output the amplified audio data to the outside, etc. The user interface includes a display device, a keyboard (not shown), a mouse (not shown), etc.

The data processing software stored in the hard disk 21 causes the doctor-side PC 20 to perform various functions as follows: a function to manage predetermined folders (a Dictation folder, a Document folder) provided on the hard disk 21; a function to download the audio data file (e.g., “AAAA6137.dss”) from the IC recorder 10 to the Dictation folder; a function to send/receive electronic mail (e-mail); a function to associate the received document data file with the audio data file stored in the Dictation folder; etc. Details of the functions provided by this data processing software will be described later.

Also, the transcription-center-side PC 30 comprises, similarly to the doctor-side PC 20, a CPU (not shown) to control each part, a storage medium (here a hard disk 31) used to store various program files such as associated data generation software of the present embodiment and various data files such as the audio data file, RAM (not shown) to temporarily store the program and data, a reproduction processing part of the audio data file (including a D/A converter to convert the audio data into the analog data, an amplifier to amplify the converted analog data, a speaker to output the amplified audio data to the outside, etc), and a user interface (a display device, a keyboard, a mouse, etc). The associated data generation software stored in the hard disk 31 causes the transcription-center-side PC 30 to perform various functions such as a function to manage predetermined folders (a reception folder, a Document folder) provided on the hard disk 31, a function to send/receive e-mail, and a function to generate the document data file corresponding to the received audio data file. Details of the functions provided by this associated data generation software will be described later.

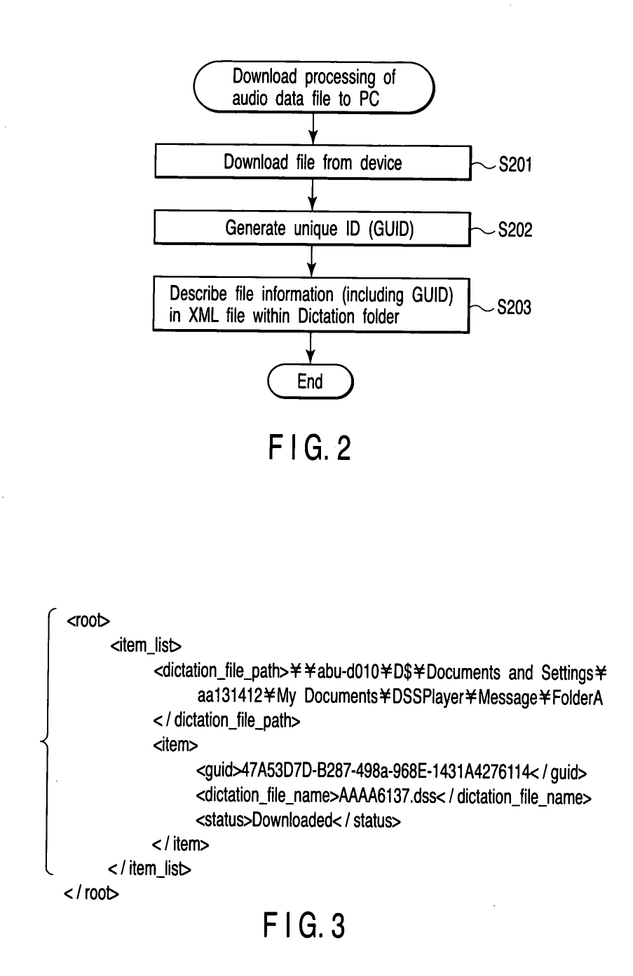

First, “download processing of the audio data file to the PC” executed by the doctor-side PC 20 in accordance with the data processing software will be described with reference to a flowchart of FIG. 2. That is, the audio data file is downloaded from the audio recording and reproduction device (IC recorder 10) connected to the doctor-side PC 20 to the Dictation folder (e.g., \\abu-d010\D$\Documents and Settings\aa131412\My Documents\DSSPlayer\Message\FolderA) of the hard disk 21 (step S201). Then, a unique ID (hereinafter noted as GUID) is generated (step S202). Thus, the data processing software and the doctor-side PC 20 function as a (first) ID generating part. After the generation of this ID, file information (including the GUID) of the downloaded audio data file is described (additionally written) in an XML file within the Dictation folder (step S203).

A content of the XML file in the Dictation folder at the time when “download processing of the audio data file to the PC” has been finished is as shown in FIG. 3. That is, in this XML file, there are described a storage location (\\abu-d010\D$\Documents and Settings\aa131412\My Documents\DSSPlayer\Message\FolderA) and a file name (AAAA6137.dss) of the downloaded audio data file, and the generated GUID (47A53D7D-B287-498a-968E-1431A4276114). The XML file in the Dictation folder thus functions as an ID information storage part and an ID association storage part.

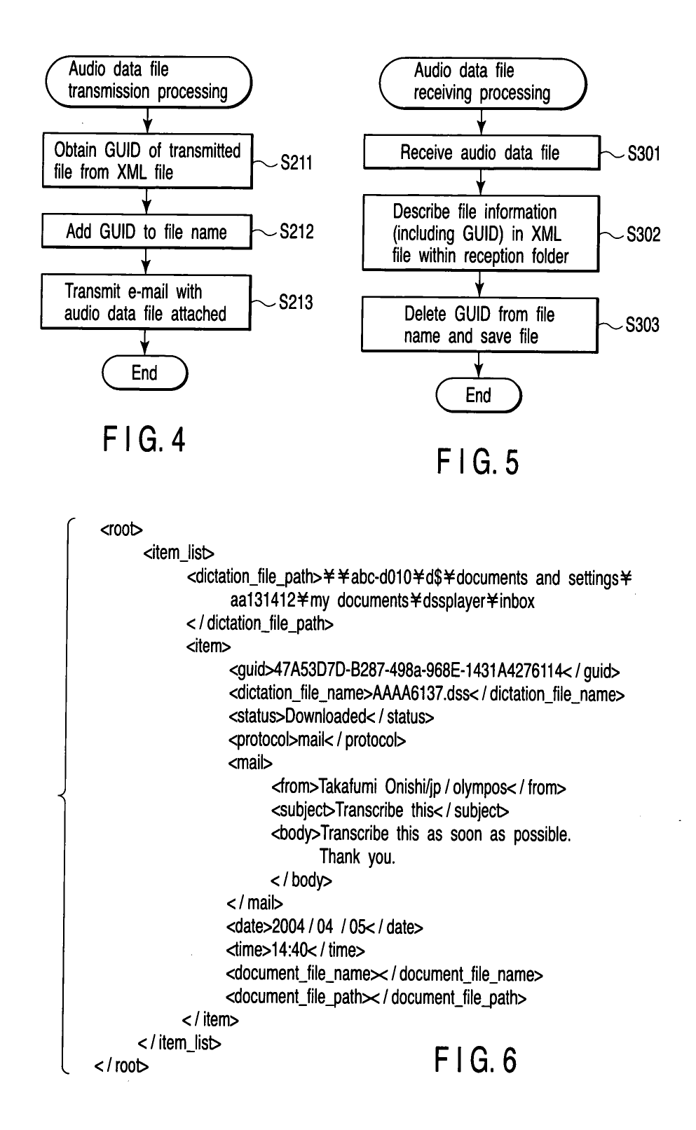

Next, “audio data file transmission processing” executed by the doctor-side PC 20 in accordance with the data processing software will be described with reference to a flowchart of FIG. 4. It is to be noted here that although not specifically shown in the drawings, what is desired to be converted into the document data file at the transcription center (e.g., the audio data file whose file name is AAAA6137.dss) has already been specified from an audio file list in the Dictation folder.

That is, the GUID (i.e., 47A53D7D-B287-498a-968E-1431A4276114) of the audio data file is obtained first which has been specified to be transmitted from the XML file in the Dictation folder (step S211). Next, by adding the obtained GUID to the file name (AAAA6137.dss) of the specified audio data file, for example, by appending the GUID to the head of the file name, an updated file name (e.g., 47A53D7D-B287-498a-968E-1431A4276114-AAAA6137.dss) is obtained (step S212). Thus, the data processing software and the doctor-side PC 20 function as a (first) ID giving part. Then, e-mail with the attached audio data file having the updated file name is transmitted to the transcription-center-side PC 30 to request conversion to the document data file (step S213). Thus, the data processing software and the doctor-side PC 20 function as a (first) transmission part.

Next, “audio data file receiving processing” executed by the transcription-center-side PC 30 in accordance with the associated data generation software will be described with reference to a flowchart of FIG. 5. First, the e-mail sent from the doctor-side PC 20 and the audio data file attached thereto are received (step S301). Thus, the associated data processing software and the transcription-center-side PC 30 function as a (second) receiving part. Then, the GUID is detected from the file name of the received audio data file to describe (additionally write) the file information (including the GUID) of the received audio data file in the XML file within the reception folder (e.g., \\abc-d010\d$\documents and settings\aa131412\my documents\dssplayer\inbox) of the hard disk 31 (step S301). It is to be noted here that the digit number and adding location of the GUID have been previously known, and the GUID is therefore easily detected from the file name. Thus, the associated data processing software and the transcription-center-side PC 30 function as an ID detection part. Further, by a file name in which the detected GUID is deleted from the file name of the received audio data file, the received audio data file is saved in the Document folder (e.g., \\abc-d010\d$\documents and settings\aa131412\my documents\dssplayer\documents) of the hard disk 31 (step S303).

Content of the XML file in the reception folder at the time when the “audio data file receiving processing” has been finished is as shown in FIG. 6. That is, there are described the storage location (\\abc-d010\d$\documents and settings\aa131412\my documents\dssplayer\inbox) and the file name (AAAA6137.dss) of the audio data file which has been received and whose file name has been changed, and the detected GUID (47A53D7D-B287-498a-968E-1431A4276114).

Next, “transcription processing” executed by the transcription-center-side PC 30 in accordance with the associated data generation software will be described with reference to a flowchart of FIG. 7. That is, the document data file having the same name as that of the audio data file is first generated in the Document folder of the hard disk 31 (step S311). Further, the file information (including the GUID) of the document data file is described (additionally written) in the XML file within the Document folder (step S312). It is to be noted here that the GUID is the GUID detected from the audio data file.

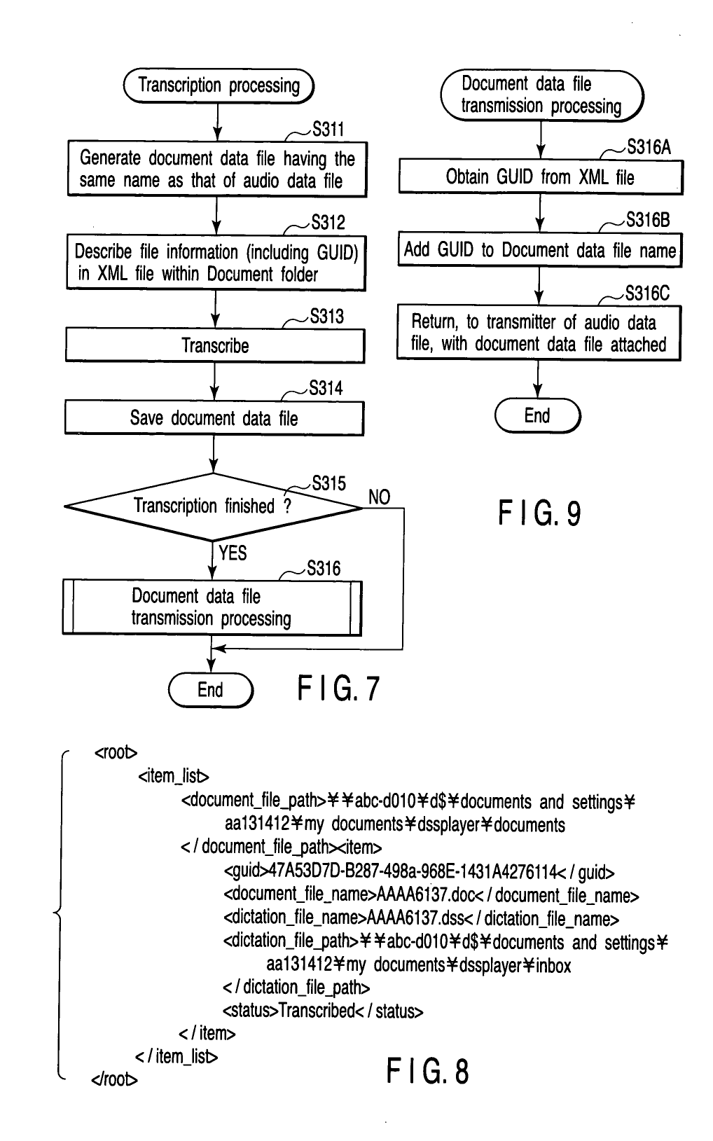

Content of the XML file in the Document folder is as shown in FIG. 8. That is, there are described the storage location (\\abc-d010\d$\documents and settings\aa131412\my documents\dssplayer\documents) and the file name (AAAA6137.doc) of the document data file created in step S311 above, and the GUID (47A53D7D-B287-498a-968E-1431A4276114), as well as the storage location (\\abc-d010\d$\documents and settings\aa131412\my documents\dssplayer\inbox) and the file name (AAAA6137.dss) of the original audio data file.

If the generation of the document data file and the description of the file information into the XML file have thus been finished, transcription from the audio data file is implemented (step S313). It is to be noted that this transcription may be conducted automatically by voice recognition software, or may be in a form that a typist types listening to the audio data file. Further, the document data file obtained as a result of this transcription is saved by the above file name in the Document folder (step S314). Thus, the associated data processing software and the transcription-center-side PC 30 function as a data file generation part.

Furthermore, a judgment is made on whether or not the transcription has been finished (step S315). This can easily be judged from whether or not status information is described, if, for example, when the transcription of the audio data file is finished, the status information indicative thereof (“Transcribed” in the example of FIG. 8) is described in the XML file within the Document folder. Moreover, if the transcription of the audio data file has not been finished, this transcription processing is finished. The transcription can be resumed by re-executing this transcription processing at a subsequent point of time. It is to be noted that in that case the processing in steps S311 and S312 above may be executed only when the audio data file is initially transcribed. That is, when the transcription is once finished and then again performed, i.e., when the audio data file has been transcribed halfway and the rest of it is again transcribed, the generation of the document data file and the description of the file information into the XML file do not have to be done again because they have already been finished. The processing in steps S311 and S312 may be executed or not by judging whether or not the file information is described in the XML file within the Document folder, or by detecting whether or not the document data file is present in the Document folder.

Furthermore, if the transcription of the audio data file has been finished (step S315), “document data file transmission processing” is executed (step S316).

In this “document data file transmission processing”, the GUID is first obtained from the XML file within the Document folder, as shown in FIG. 9 (step S316A). Next, the obtained GUID is added to the file name (AAAA6137.doc) of the generated document data file, for example, the GUID is appended to the head of the file name, thereby obtaining an updated file name (e.g., 47A53D7D-B287-498a-968E-1431A4276114-AAAA6137.doc) (step S316B). Thus, the associated data processing software and the transcription-center-side PC 30 function as a (second) ID giving part. Then, e-mail with the attached document data file having the updated file name is returned to the doctor-side PC 20 which is the transmitter of the audio data file (step S316C). Thus, the associated data processing software and the transcription-center-side PC 30 function as a (second) transmission part.

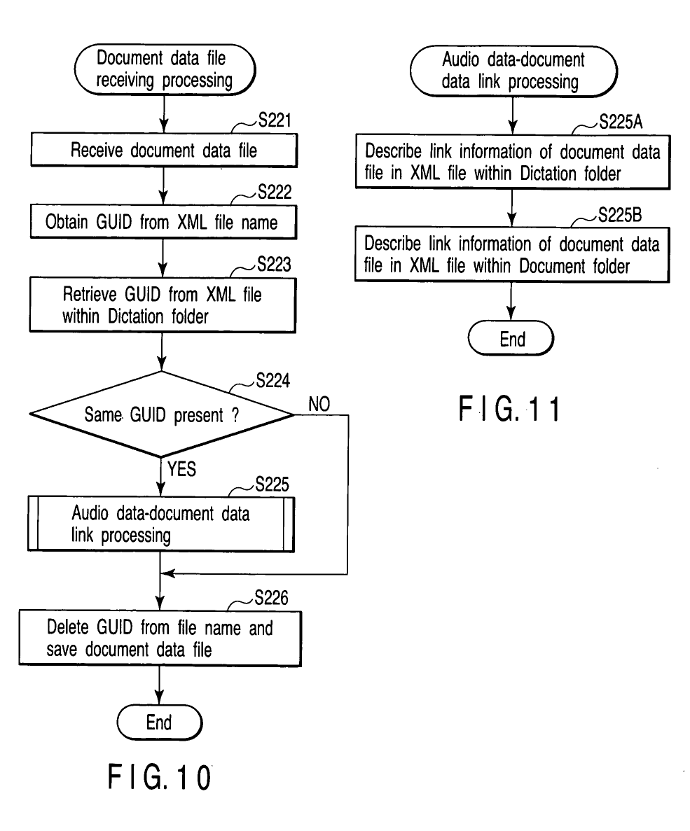

Next, “document data file receiving processing” executed by the doctor-side PC 20 in accordance with the data processing software will be described with reference to a flowchart of FIG. 10. That is, the returned e-mail and the audio data file attached thereto from the transcription-center-side PC 30 are first received (step S221). Thus, the data processing software and the doctor-side PC 20 function as a (first) receiving part. Then, the GUID is obtained from the file name of the received document data file (step S222). It is to be noted here that the digit number and adding location of the GUID have been previously known, and the GUID is therefore easily extracted from the file name. Thus, the data processing software and the doctor-side PC 20 function as an ID detection part. Further, what corresponds to the obtained GUID is retrieved from the XML file within the Dictation folder (step S223). Here, if the same GUID is present in the XML file (step S224), “audio data—document data link processing” is executed (step S225).

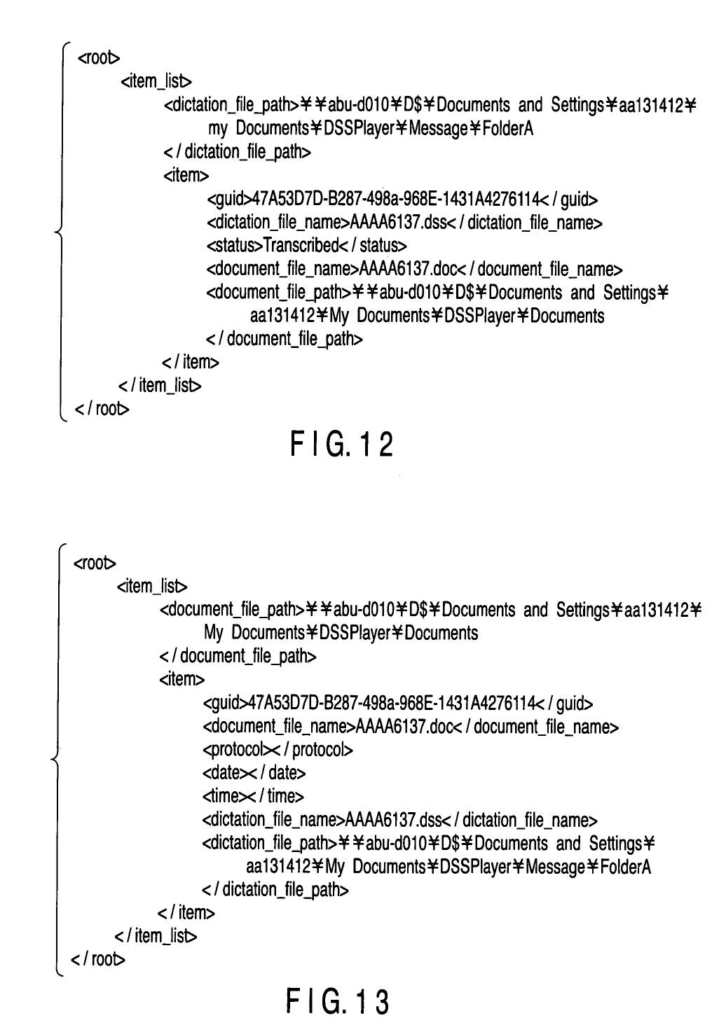

In this “audio data—document data link processing”, link information of the document data file is described (additionally written) in the XML file within the Dictation folder, as shown in FIG. 11 (step S225A). Content of the XML file in the Dictation folder in which the link information is described is as shown in FIG. 12. That is, into the content shown in FIG. 3, the storage location (\\abu-d010\D$\Documents and Settings\aa131412\My Documents\DSSPlayer\Documents) and the file name (AAAA6137.doc) of the document data file are additionally written as the link information. Moreover, “Transcribed” is additionally written as the status information. Further, the link information of the audio data file is described (additionally written) in the XML file within the Document folder (e.g., \\abu-d010\D$\Documents and Settings\aa131412\My Documents\DSSPlayer\Documents) (step S225B). Content of the XML file within the Document folder in which the link information is described is as shown in FIG. 13. That is, as the file information of the document data file, there are described the storage location (\\abu-d010\D$\Documents and Settings\aa131412\My Documents\DSSPlayer\Documents) and the file name (AAAA6137.doc) of the document data file, and the GUID (47A53D7D-B287-498a-968E-1431A4276114). Moreover, as the link information, there are described the storage location (\\abu-d010\D$\Documents and Settings\aa131412\My Documents\DSSPlayer\Message\FolderA) and the file name (AAAA6137.dss) of the audio data file. Thus, the data processing software and the doctor-side PC 20 function as an associating part.

If this “audio data—document data link processing” is finished, by the file name in which the obtained GUID is deleted from the file name of the received audio data file, the document data file is saved in the Document folder on the hard disk 21 (step S226). It is to be noted that if the result of the retrieval in step S223 above is such that the same GUID is not in the XML file (step S224), the link processing cannot be performed. Therefore, in such a case, proceeding immediately to this step S226, the document data file is saved by the file name in which the obtained GUID is deleted from the file name of the received document data file.

While the present invention has been described above with reference to the one embodiment, the present invention is not limited to the embodiment described above, various modifications and applications can naturally be made within the spirit of the present invention. For example, in the one embodiment described above, the audio data file attached to the e-mail is transmitted from the doctor-side PC 20 to the transcription-center-side PC 30, and the corresponding document data file similarly attached to the e-mail is returned, but the data files may also be exchanged via an FTP server.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

1. A data processing apparatus comprising:
a storage medium configured to store a first data file;
an ID generating part configured to generate an ID to identify the first data file stored in the storage medium;
an ID information storage part configured to store the ID generated by the ID generating part in association with the first data file;
an ID giving part configured to give the ID generated by the ID generating part to the first data file stored in the storage medium;
a transmission part configured to transmit, to an associated data generation apparatus, the first data file to which the ID has been given by the ID giving part;
a receiving part configured to receive a second data file generated in the associated data generation apparatus;
an ID detection part configured to detect the ID given to the second data file received at the receiving part; and
an associating part configured to collate the ID detected by the ID detection part with the ID stored in the ID information storage part, and associate the first data file with the second data file.

2. The apparatus according to claim 1, wherein
the first data file includes an audio data file, and
the second data file includes a document data file.

3. The apparatus according to claim 1, wherein
the ID giving part is configured to give the ID to a file name of the first data file, and
the ID detection part is configured to detect the ID from the file name of the second data file.

4. The apparatus according to claim 3, further comprising a save part configured to save the second data file after deleting the ID from the file name of the second data file received at the receiving part.

5. An associated data generation apparatus comprising:
a receiving part configured to receive a first data file transmitted from a data processing apparatus;
an ID detection part configured to detect an ID given to the first data file received at the receiving part;
a data file generation part configured to generate a second data file associated with the first data file;
an ID giving part configured to give the ID detected by the ID detection part to the second data file generated by the data file generation part; and
a transmission part configured to transmit, to the data processing apparatus, the second data file to which the ID has been given by the ID giving part.

6. The apparatus according to claim 5, wherein
the first data file includes an audio data file, and
the second data file includes a document data file.

7. The apparatus according to claim 5, wherein
the ID detection part is configured to detect the ID from a file name of the first data file, and
the ID giving part is configured to give the ID to a file name of the second data file.

8. A data processing system which transmits a first data file subjected to at least one of recording and processing in a data processing apparatus having first transmission and receiving parts, to an associated data generation apparatus having second transmission and receiving parts and which transmits a second data file generated by the associated data generation apparatus to the data processing apparatus, the data processing system comprising:
the data processing apparatus including:
a storage medium configured to store the first data file;
an ID generating part configured to generate an ID to identify the first data file stored in the storage medium;
an ID association storage part configured to store the ID generated by the ID generating part in association with the first data file;
a first ID giving part configured to give the ID generated by the ID generating part to the first data file stored in the storage medium; and
the first transmission part configured to transmit, to the associated data generation apparatus, the first data file to which the ID has been given by the first ID giving part, and
the associated data generation apparatus including:
the second receiving part configured to receive the first data file which has been transmitted from the first transmission part of the data processing apparatus and to which the ID has been given;
a data file generation part configured to generate the second data file associated with the first data file received at the receiving part;
a second ID giving part configured to give the ID which has been given to the first data file serving as an original of the second data file, to the second data file generated by the data file generation part; and
the second transmission part configured to transmit, to the data processing apparatus, the second data file to which the ID has been given by the second ID giving part, wherein
the data processing apparatus further includes:
the first receiving part configured to receive the second data file which has been transmitted from the second transmission part of the associated data generation apparatus and to which the ID has been given;
an ID detection part configured to detect the ID given to the second data file received at the first receiving part; and
an associating part configured to associate the first data file with the second data file in accordance with the ID detected by the ID detection part and information stored in the ID association storage part.

9. A data processing software which causes a computer to perform data communication with an associated data generation apparatus, the data processing software causing the computer to perform:
a function to cause one of a user and the computer to select a first data file stored in a storage medium under the control of the computer;
a function to generate an ID to identify the selected first data file;
a function to store the generated ID in association with the first data file;
a function to give the ID to the first data file;
a function to transmit, to the associated data generation apparatus, the first data file to which the ID has been given;
a function to receive the second data file generated in the associated data generation apparatus;
a function to detect the ID given to the received second data file; and
a function to collate the detected ID with the stored ID, and associate the first data file with the second data file.

10. The software according to claim 9, wherein
the first data file includes an audio data file, and
the second data file includes a document data file.

11. The software according to claim 9, wherein
the function to give the ID causes the computer to give the ID to a file name of the first data file, and
the function to detect the ID causes the computer to detect the ID from a file name of the second data file.

12. The software according to claim 9, wherein the computer is further caused to perform:
a function to save the second data file after deleting the ID from the file name of the second data file.

13. An associated data generation software which causes a computer to perform data communication with a data processing apparatus, the associated data generation software causing the computer to perform:
a function to receive a first data file transmitted from the data processing apparatus;
a function to detect an ID given to the received first data file;
a function to generate a second data file associated with the received first data file;
a function to give the detected ID to the generated second data file; and
a function to transmit, to the data processing apparatus, the second data file to which the ID has been given.

14. The software according to claim 13, wherein
the first data file includes an audio data file, and
the second data file includes a document data file.

15. The software according to claim 13, wherein
the function to detect the ID causes the computer to detect the ID from a file name of the first data file, and
the function to give the ID causes the computer to give the ID to a file name of the second data file.

16. A data processing method of performing data communication with an associated data generation apparatus to process data, the method comprising:
selecting a first data file stored in a storage medium;
generating an ID to identify the selected first data file;
storing the generated ID in association with the first data file;
giving the ID to the first data file;
transmitting, to the associated data generation apparatus, the first data file to which the ID has been given;
receiving the second data file generated in the associated data generation apparatus;
detecting the ID given to the received second data file; and
collating the detected ID with the stored ID, and associating the first data file with the second data file.

17. An associated data generating method of generating a second data file associated with a first data file transmitted from a data processing apparatus, the method comprising:
receiving the first data file transmitted from the data processing apparatus;
detecting an ID given to the received first data file;
generating a second data file associated with the first data file;
giving the detected ID to the generated second data file; and
transmitting, to the data processing apparatus, the second data file to which the ID has been given.

18. A data processing method in which a first data file is transmitted from one side to another side, and a second data file associated with the first data file is generated at the another side and transmitted to the one side in order to process data, the method comprising:
at the one side
generating an ID to identify the first data file stored in a storage medium;
storing the generated ID in association with the first data file;
giving the generated ID to the first data file; and
transmitting, to the another side, the first data file to which the ID has been given, and
at the another side
receiving the first data file to which the transmitted ID is given;
generating the second data file associated with the received first data file;
giving the ID which has been given to the first data file serving as an original of the second data file, to the generated second data file; and
transmitting, to the one side, the second data file to which the ID has been given, wherein
further at the one side
receiving the second data file to which the ID has been given;
detecting the ID of the received second data file; and
associating the first data file with the second data file in accordance with the detected ID and the ID stored in the one side.
